(19) United States
(12) Patent Application Publication
(10) Pub. No.: US 2025/0329914 A1
(43) Pub. Date: Oct. 23, 2025

(54) Device, and Method of Manufacture of a Device

(71) Applicant: Telefonaktiebolaget LM Ericsson (publ), Stockholm (SE)

(72) Inventors: Ola Tageman, Göteborg (SE); Benny Gustafson, Spånga (SE); Agneta Ljungbro, Bjärred (SE); Tony Josefsson, Sandhult (SE)

(21) Appl. No.: 18/864,075

(22) PCT Filed: May 10, 2023
(86) PCT No.: PCT/EP2023/062414

§ 371 Date: Nov. 8, 2024

Related U.S. Application Data
(60) Provisional application No. 63/340,077, filed on May 10, 2022.

(51) Int. Cl. H01Q 1/22; H01Q 9/04; H01Q 21/06

(52) U.S. Cl. CPC H01Q 1/2283; H01Q 9/0414; H01Q 21/06

(57) ABSTRACT

Devices and methods of manufacture of devices are disclosed. In an example, a device comprises at least one package and at least one component, wherein each package comprises at least one integrated circuit and at least one primary antenna and each component comprises at least one secondary antenna. The at least one component is attached to the at least one package by adhesive such that each secondary antenna is spaced from and stacked with one of the at least one primary antenna.

### TECHNICAL FIELD

Embodiments of this disclosure relate to a device, such as for example a wireless communication device, that includes at least one package and at least one component, and a method of manufacture of such as device.

### BACKGROUND

With increasing frequency of wireless communication, the number of antenna elements in a wireless communication device may increase, and the area per antenna reduces due to the increasing frequency. This leads to the following:
Smaller space for active circuits and for package overhead around active circuits. It is desired to be able to have active circuits covering the area behind antenna elements.
It is not practical to place part of the high frequency electronics for an antenna element far from the antenna element and use fan-out routing between antenna elements and active circuits. Further, the need to keep the same routing length for each antenna element makes this difficult. It is thus desired to put all high frequency electronics in the area covered by each antenna element.
Small sized via transitions are needed to fit in the available space, and to have small pads with low capacitance. It is normally necessary to use thin dielectric layers to manufacture small size vias.
Small solder balls are required to support high frequency operation (resulting in small pad capacitance and small openings in the ground structure around the RF-path). Small solder balls are also required to fit the number of signal and ground connections.
High precision interconnects (traces, vias, solder balls, layer thickness, gaps) are needed for high frequency operation. This corresponds to tight manufacturing tolerances and is normally provided by thin layer technologies.

Antenna in package is a popular concept for this case. However, using an antenna in package concept at higher frequencies in general gives several fundamental challenges.

It is difficult to get materials suitable for the antenna that also are useful as package materials (e.g. low dielectric constant (Dk), low loss, fine-grained). For a large bandwidth, it is beneficial to use low Dk dielectric to avoid blindness and poor active match, while maintaining large scan range and low loss. A fence of ground vias can to some extent help in case low Dk materials are not available, but in that case one must divide the thick antenna layer into many thin layers to accommodate small enough vias. This increases complexity and non-planarity. The choice of material is restricted since many other aspects must be considered (e.g. molding, non-planarity, coefficient of thermal expansion (CTE)-mismatch, IC-protection).

Thick layers are needed to make an antenna with good properties (low loss, wideband, wide scan, well matched). This is not straightforward to achieve in an Antenna in Package (AiP). It is difficult to achieve the thick layers needed for antenna and for low loss routing of high frequency signals and at the same time have fine feature vias. Thick layers of dielectric are also preferred to keep loss low in any routing at high frequency. Depending on implementation, such routing is needed between antenna elements and active circuits, and/or between different active circuits. It is also important to try to minimize the routing distance and number of transitions to keep the loss low. It is difficult to make all the many layers needed to accumulate enough total thickness. Further, additional layers may be needed for internal routing in the package (to package terminals, and optionally between active circuits). It is also difficult to maintain good planarity with many and thick layers, across a large package.

Reduced package size improves yield in several steps but leads to overhead in terms of overall size. It is difficult to make a package large enough to fit a large fraction of the antennas of a whole array. Large packages are difficult to make and difficult to mount on a PCB. Without large packages there tends to be too much package overhead, and challenging routing on the PCB, more transitions and longer routing. This makes it difficult to add pieces to scale up to a large array with lambda half spacing maintained throughout the whole array.

The higher the frequency, the larger the relative area covered by active circuits. This will rule out concepts that require large area overhead for terminals or other objects or structures. Multiple active circuits in one package are preferred to improve the yield of the active circuits. This tends to make the package less rigid and less flat, and it requires more advanced routing internally.

Assembly yield (when a package is soldered to a printed circuit board (PCB)) is strongly dependent on package size, package planarity and solder ball size. Larger solder ball size generally improves assembly yield since it gives larger tolerance to non-planarity. On the other hand, small solder balls are required to support high frequency operation and to fit all signals within the unit cell dictated by the antenna grid. Board level reliability is strongly dependent on package size, Coefficient of Thermal Expansion (CTE) mismatch and solder ball size.

Package manufacturing yield in general depends on many things, such as e.g. CTE mismatch, number of layers, thickness of layers, etc. A package with a few thin layers, and materials tailored with regards to planarity alone, can have high yield, while more exotic packages can have very poor yield and require time consuming experimentation with material combinations and put severe restrictions on layout (copper density, cheese and fill). Complex package fabrication gives poor yield and high cost. Package planarity is challenging to achieve for multilayer packages. Ideally, the package should be planar both at room temperature and at soldering temperatures. Package planarity is dependent on many things, in particular on CTE mismatch between layers inside the package, and glass transition temperatures (Tg) of different materials in the package and on Young's modulus of the layers. When one layer is fully cured and has partial metal coverage, these parameters differ from those of the layer about to be cured and patterned next. Sequential curing, layer by layer, during lamination or molding therefore tends to give more and more non-planarity for each step. With increasing layer count, and the thicker the layers are, the more challenging it becomes to keep planarity under control. The temperature change during curing is an important parameter, since the stress induced by CTE mismatch is roughly proportional to the temperature change during curing. To keep the throughput high in manufacturing, it is desired to use high curing temperature especially when many layers are needed. In brief, planarity is difficult to achieve for many layers, and/or for thick layers.

Increasing non-planarity during package manufacturing makes it more and more difficult to maintain yield in coming steps, since it gets difficult fit masks to a non-planar surface, and since planarization will introduces varying thickness. This leads to poor resolution and alignment between layers, which in turn makes it inappropriate for high frequency antennas (needing fine features with high precision).

In summary, while some packaging technology allows high precision and dense integration, it is difficult to include a thick antenna with special materials, and to maintain package planarity.

In U.S. Pat. No. 10,594,019, there is an air gap, lid, and complicated assembly of large parts for the complete package. Keeping gap tolerance over large free-hanging distance is needed. Soldering of large package (70×70 mm) to a PCB requires large solder balls, which will limit bandwidth to a few GHz. Active circuits and solder balls compete for space on the bottom side of the package. At high frequency one would like to have active circuits covering most of the package, leaving no space for solder balls. Core layer in laminate substrate does not allow for the fine resolution needed to support/handle high frequency signals and small area per antenna element. A further drawback is that there is no place to put R, L and C components in the package.

In US 2021/0273323, cavities filled with air or special material is an important feature. Cavities are difficult to manufacture at higher frequency since dimensions go down and tolerance requirements get challenging. Several added manufacturing steps are disclosed. Exotic and expensive fabrication is needed. The devices presented are not suitable for high frequency.

Further, the use of laminate substrate is problematic at high frequency due to design rule limitations when scaling down-size and tolerance requirements. Variations in dielectric constant of resin and glass fabric, thickness control, high loss material, are limiting the applicability at high frequency. At high frequency there will be active circuits covering most of the package, leaving no space for solder balls. Core layer in laminate substrate does not allow fine resolution needed to support handle high frequency signals and small area per antenna element. A further drawback is that there is no place to put R, L and C components in the package.

US 2020/0185299 discloses use of conductive lines that make non-galvanic (isolating) connection to antenna. This leads to very poor coupling, and narrow bandwidth, about 1.5% in FIG. 3E. This leads to excessive loss, and large sensitivity to tolerances in manufacturing.

The antenna elements are placed on a mold layer made during package manufacturing. It is difficult to get such a mold layer with the right material properties, sufficient thickness, and limited warpage. The solution only includes a single antenna layer. Feed lines are required since some antennas are outside the area of the active circuit. A slot feed is shown in the figures. The solution does not allow scaling to higher frequency and multiple packages side by side, since there will be no place to put solder balls when active circuits occupy most of the area, and since the thermal concept requires there to be solder balls on all sides to reliably press the package down to the heat sink.

U.S. Pat. No. 10,608,319 discloses an antenna part containing the complete antenna. Galvanic connection required between the antenna and the package (soldering, or plating). Vias/walls are needed in all layers. To scale to higher frequency, via-walls must shrink, which would require multiple layers. Low Dk material is not discussed or used.

### SUMMARY

Certain aspects of the disclosure and their embodiments may provide solutions to these or other challenges, and may provide one or more of the following technical advantage(s). For example, by attaching one or more components or top parts to one or more packages or bottom parts, the package may be easier to manufacture. In particular, embodiments of this disclosure may for example mitigate package warpage problems often associated with complex AiPs. There may also be less complex package manufacturing when a thick part of an antenna is made separately from the package(s) that contain IC(s). Techniques similar to High-Density Fan-Out (HDFO) type of package can be used in some examples to manufacture package(s). Package(s) can in some examples have fewer and thinner layers, which allows finer via features and less warpage. Package material selection can in some examples focus on CTE-matching and planarity.

One aspect of the present disclosure provides a device comprising at least one package and at least one component, wherein each package comprises at least one integrated circuit and at least one primary antenna. Each component comprises at least one secondary antenna. The at least one component is attached to the at least one package by adhesive such that each secondary antenna is spaced from and stacked with one of the at least one primary antenna.

Another aspect of the present disclosure provides method of manufacture of a device. The method comprises attaching at least one component to at least one package using adhesive, wherein each package comprises at least one integrated circuit and at least one primary antenna, and wherein each component comprises at least one secondary antenna. The at least one component is attached to the at least one package such that each secondary antenna is spaced from and stacked with one of the at least one primary antenna.

### BRIEF DESCRIPTION OF THE FIGURES

For a better understanding of the embodiments of the present disclosure, and to show how it may be put into effect, reference will now be made, by way of example only, to the accompanying figures, in which:

FIG. 1 shows a cross-section of shows a device according to an example embodiment of this disclosure;

FIG. 2 shows a cross section of another example of a device according to an embodiment of this disclosure;

FIG. 3 shows a cross section of an example of a package;

FIG. 4 shows a cross section of an example of a component;

FIG. 5 shows a cross section of another example of a device according to embodiments of this disclosure;

FIG. 6 shows a cross section of another example of a device according to embodiments of this disclosure;

FIG. 7 shows a cross section of a part of an example of a package;

FIG. 8 shows a cross section of a part of another example of a package;

FIG. 9 shows a cross section of a part of another example of a package;

FIG. 10 shows a cross section of another example of a device according to embodiments of this disclosure;

FIG. 11 shows a cross section of another example of a component;

FIG. 12 is a flow chart of another example of a method of manufacture of a device;

FIG. 13 is a flow chart of another example of a method of manufacture of a device;

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

### DETAILED DESCRIPTION OF EXAMPLE EMBODIMENTS

Some examples of the embodiments contemplated herein will now be described more fully with reference to the accompanying drawings. Example embodiments are provided by way of example to convey the scope of the subject matter to those skilled in the art.

Examples of this disclosure include a device comprising at least one package and at least one component, wherein each package comprises at least one integrated circuit and at least one primary antenna. Each component comprises at least one secondary antenna. The at least one component is attached to the at least one package by adhesive such that each secondary antenna is spaced from and stacked with one of the at least one primary antenna.

In some examples, it may be simple to manufacture one or more components that include one or more secondary antennas, for example with a thick dielectric layer and with metal patches on a top side, attached to one or more packages, for example using non-conducting joining to primary antenna bottom-part(s) containing, for example, thin dielectric layer(s) and fine resolution vias. The top part(s) may be attached after assembling the bottom part(s) to the PCB in some examples, although in other examples the top part(s) may be attached to the bottom part(s) before assembly onto the PCB.

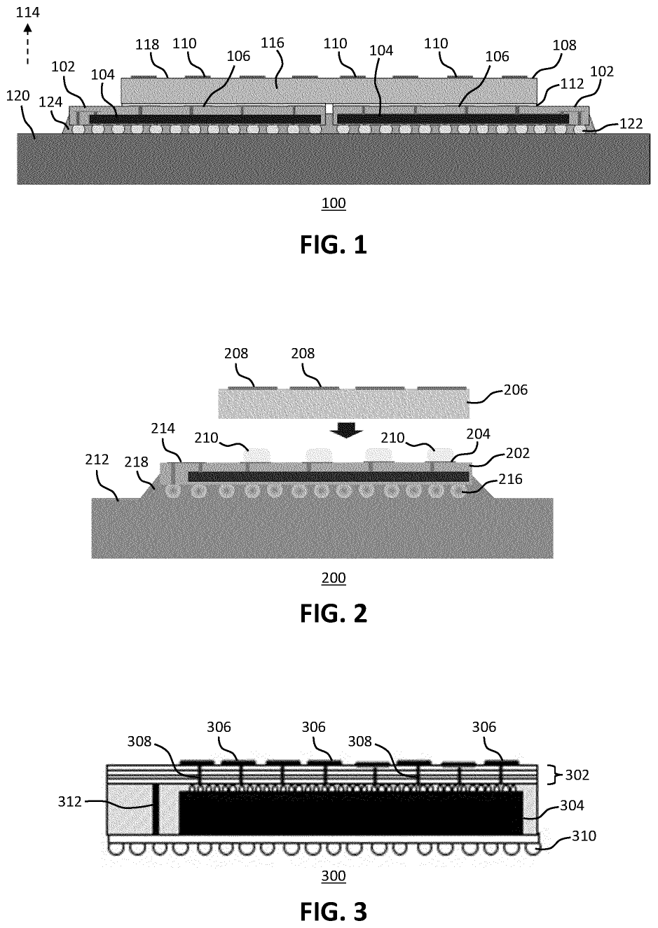

FIG. 1 below shows a cross-section of a device 100 according to an example embodiment of this disclosure. The device 100 includes two packages 102, each package 102 comprising at least one integrated circuit (IC) 104 and a plurality of primary antennas 106. The device 100 also includes a component 108 including a plurality of secondary antennas 110. The component 108 is attached to the packages by adhesive 112 such that each secondary antenna is spaced from and stacked with one of the at least one primary antenna. That is, for example, the primary antennas and secondary antennas may be generally planar. Additionally or alternatively, the primary antennas and the secondary antennas may generally be disposed within a respective plane, where the planes are substantially parallel. Each secondary antenna may be over one of the at least one primary antenna in a direction substantially perpendicular to the planes in some examples, shown as direction 114 in FIG. 1.

In examples of this disclosure, component(s) such as component 108 may be referred to as top part(s), and package(s) such as packages 102 may be referred to as bottom part(s), in view of the orientation of the component and packages in FIG. 1, though this is merely an illustrative example and nomenclature and any device orientation is possible. The example device 100 shown in FIG. 1 includes secondary antennas 110 in the top part, with a thick dielectric layer 116 and secondary antenna patches/elements on the top side 118, the top part being attached with non-conducting adhesive 112 to the bottom-parts (e.g. onto the primary antennas 106 in the bottom parts), where the bottom part(s) may in some examples have thin dielectric layer(s) and fine resolution vias and patterning.

In some examples, the device 100 (or any device according to this disclosure) may be manufactured in a method that uses one or more of the following steps: 1. Make top part. 2. Make bottom part. 3. Singulate bottom part. 4. Solder base part to PCB. 5. Apply underfill (if required). 6. Apply non-conductive adhesive to either the top part and/or the bottom part. 7. Attach top part on to base part.

Optionally, component(s) or top part(s) of devices such as device 100 may in some examples be attached across multiple different packages (bottom parts). The underlying primary antennas can in some examples be adjusted to account for the proximity to the edge of the device/package of some primary antennas.

Embodiments of this disclosure may allow assembly of a thin package with good planarity. There is no thick layer present in the package(s) in some examples. In some examples, a thick layer may be for example a layer that has a thickness suitable for antennas, which is significantly thicker than layers normally used for signal routing. Signal routing layers are for example in the range 3-30 um in a package, while antenna layers are typically 5-20% of the wavelength, which for example at 100 GHz is 75-300 um. Underfill can be applied to lock the package on a PCB in some examples, such as for example a PCB 120 shown in FIG. 1. The package may for example be kept straight by the PCB and underfill during attachment of the top part(s). The device 100 may include solder balls 122 that are used to provide mechanical and possibly electrical connection between the PCB 120 and the bottom package(s) 102. The device 100 may also include optional underfill material 124 between the PCB 120 and the bottom packages 102 and surrounds the solder balls 122, and is primarily used to enhance the reliability of the solder balls 122.

In some examples, the top part can be added without high temperature (e.g. as a last process step) and can be fully cured after leaving the manufacturing line. No further processing is needed after mounting the top part (no drilling, plating, etching etc). The top part can be manufactured separately from the bottom part. Thus, the top part can in some examples use a low permittivity material that will improve antenna performance, and this would be very difficult to implement in an AiP. Thick, low-Dk, low loss materials are thus possible for the component(s)/top part(s) in example embodiments of this disclosure.

In some examples, the top part(s) only needs to cover the section of the primary antenna bottom package where the bottom package has its topside antenna signals. The top part(s) can in some examples be placed over one antenna bottom package or over multiple bottom packages. By having a top part that covers several bottom parts, gaps in the antenna array can be avoided. A common antenna layer may for example allow smaller added distance between antenna patches across gaps. The top part can in some examples be extended outside the package(s) to hide structures, and to add electromagnetic structures around the array (e.g. to electrically connect the package(s) for external signals).

High precision can be achieved with simple means in some examples. There may be no critical alignment within the top part, since in some examples the top part does not require patterning on both sides, and in some examples there may be no vias in the top part(s)/component(s) (e.g. as in the device 100 of FIG. 1). The contour can be cut relative to the patch pattern. The top part(s) can be placed with reference to a visible pattern or marks on top of the bottom part(s)/package(s) in some examples.

Example embodiments of this disclosure focus on antenna integration at high frequency, for example around 100 GHz, and more generally for example around 50-300 GHz.

A first example of this disclosure, as indicated above, comprises a device comprising at least one package, wherein each package comprises at least one integrated circuit and at least one primary antenna. The device also comprises at least one component, wherein each component comprises at least one secondary antenna. The at least one component is attached to the at least one package by adhesive such that each secondary antenna is spaced from and stacked with one of the at least one primary antenna.

Thus, the package(s) (also referred to herein as bottom part(s)) and the component(s) (also referred to herein as top part(s)) can be manufactured separately, which may in some examples result in simpler manufacture and/or assembly, and/or devices with desired or improved properties. The attachment of the component(s) to the package(s) may also be a simple process in some examples.

In a second example of this disclosure, a device is disclosed comprising at least one package, wherein each package comprises at least one integrated circuit and a plurality of primary antennas; and at least one component, wherein the component comprises a plurality of secondary antennas. The at least one component is attached to the at least one package by solder such that each secondary antenna is spaced from and stacked with one of the at least one primary antenna, wherein portions of the solder are between at least two primary antennas and/or at least two secondary antennas.

That is, for example, portions of the solder (where the portions may be for example one or more solder balls) may be between two (or more) primary antennas. In addition, or alternatively, in some examples, portions of the solder may be between two (or more) secondary antennas. In such examples the purpose of the solder is to mechanically fix the component to the package in areas around the antennas, rather than to provide electrical connection.

A further example of this disclosure provides a method of manufacture of a device (e.g. a device according to the first example of this disclosure referred to above). The method comprises attaching at least one component to at least one package using adhesive;

wherein each package comprises at least one integrated circuit and at least one primary antenna, and wherein each component comprises at least one secondary antenna. The at least one component is attached to the at least one package such that each secondary antenna is spaced from and stacked with one of the at least one primary antenna.

Another example of this disclosure provides a method of manufacture of a device (e.g. a device according to the first example of this disclosure referred to above). The method comprises attaching at least one component to at least one package using solder; wherein each package comprises at least one integrated circuit and a plurality of primary antennas, and wherein each component comprises a plurality of secondary antennas. The at least one component is attached to the at least one package such that each secondary antenna is spaced from and stacked with one of the at least one primary antenna, and portions of the solder are between at least two primary antennas and/or at least two secondary antennas.

In some examples of this disclosure, the method of manufacture (which may be either of the examples referred to above) may comprise mounting the device or the at least one package on a printed circuit board (PCB) after attaching the at least one component to the at least one package. Alternatively, for example, the method may comprise mounting the at least one package on a printed circuit board (PCB) before attaching the at least one component to the at least one package. The method may also comprise underfilling at least the at least one package on the PCB in some examples.

In some examples (which may refer to either of the example devices referred to above, or the methods of manufacture thereof), the at least one package comprises one package, and wherein the package includes a plurality of primary antennas. The at least one component may for example comprises a plurality of components, and wherein each of the components includes at least one secondary antenna; or may comprise for example one component, and wherein the component includes a plurality of secondary antennas.

Alternatively, for example the at least one component comprises one component. The at least one package may then for example comprise one package. The at least one package may instead in some examples comprise a plurality of packages, each of the packages including at least one primary antenna, and the component including a plurality of secondary antennas.

As indicated above, each secondary antenna is spaced from and stacked with one of the at least one primary antenna. That is, for example, one or more of the following may apply:
each secondary antenna is substantially parallel to at least one primary antenna;
an area over the at least one package occupied by each secondary antenna is substantially equal to an area over the at least one package occupied by at least one primary antenna (e.g. they have substantially the same “footprint” over the package(s), that is, for example, they have substantially the same footprint or occupy substantially the same area on respective planes that are substantially parallel to the general plane of the package(s) or an upper surface of the package(s));
each primary antenna is at least partially covered by at least one secondary antenna;
each primary antenna is underneath at least one secondary antenna;
each secondary antenna is located to be able to induce a signal in at least one primary antenna (during reception); and/or. each primary antenna is located to be able to induce a signal in at least one secondary antenna (during transmission)

Additionally or alternatively, in some examples, one or more of the following may apply:
each primary antenna is substantially equal in size and/or shape to at least one secondary antenna;
there is no direct electrical connection between each primary antenna and any secondary antenna;
there is no air gap between the at least one package and the at least one component.

Each of the at least one component includes a substrate in some examples. The substrate may be for example a low dielectric constant (Dk) substrate, e.g. in a range 1-1.5, 1-2, or 1-2.5.

Each component may in some examples comprises a surface, e.g. an upper surface (when considering the package(s) are below the component(s)), wherein the at least one secondary antenna is on the surface. The surface may be for example substantially parallel to and facing away from the at least one package. The at least one component may also in some examples include a further surface, wherein the further surface is opposite the surface. This further surface may be for example the surface that is attached to the package(s) via the adhesive or solder. In some examples, at least one component includes at least one further antenna on the further surface of the component, and wherein each further antenna is between one of the at least one primary antenna and one of the at least one secondary antenna and is separated from the primary antenna. Thus for example the further antenna(s) may be “over” a primary antenna and “under” a secondary antenna. Each further antenna may in some examples separated from the primary antenna by at least the adhesive.

In some examples, at least one component may include at least one projecting feature on the further surface that contacts a surface of at least one package. This may for example ensure that the package(s) and component(s) are separated by a fixed distance (apart from the projections) during the process of attaching the component(s) to the package(s). Additionally or alternatively, in some examples, at least one package includes at least one projecting feature that contacts a surface of at least one component.

In some examples, the at least one component may cover at least part of the at least one package. For example, the at least one component may extend beyond at least one edge of the at least one package. The component could in some examples include apparatus (e.g. traces, vias etc.) for providing one or more signals to at least one package and/or conveying one or more signals from the at least one package. That is, for example, the component may provide electrical connections to the package(s) for external signals. In some examples, a part of the adhesive is electrically conductive for electrically connecting the at least one component to the apparatus. In some examples, the at least one component does not cover all of the at least one package.

The at least one package may in some examples includes at least one via electrically connected to the at least one primary antenna. For example, the at least one package includes at least one via electrically connecting at least one primary antenna to the at least one integrated circuit.

In some examples, the at least one package includes at least one first ground conductive portion adjacent to at least one primary antenna, wherein the at least one ground conductive portion is for connection to ground. Additionally or alternatively, for example, the at least one package includes at least one second ground conductive portion under at least one primary antenna. The at least one second ground conductive portion may in some examples include or form at least one aperture for providing a signal to the at least one primary antenna. There is typically one common ground area, which has holes or apertures in it for passing vias or for passing electromagnetic fields.

In some examples, the device may include at least one further component comprising at least one further secondary antenna, wherein the at least one further component is attached to the at least one component by adhesive such that each further secondary antenna is spaced from and “over” one of the at least one secondary antenna. That is, for example, a further secondary antenna may be “over” both a secondary antenna and a primary antenna. Thus, for example, the at least one further component may be placed on top of the component(s), on the other side of the component(s) to the package(s).

The thickness of the at least one component may in some examples be in a range 100-500 μm.

The adhesive (in examples where adhesive is used) may in some examples be electrically non-conductive, and/or the adhesive comprises a dispensed liquid adhesive, adhesive tape and/or an adhesive film.

The at least one package may be for example at least one integrated circuit embedded in a printed circuit board laminate stack, and/or at least one integrated circuit embedded in a package with one or more molded dielectric layers or RDL layers.

Embodiments of this disclosure may also include apparatus or equipment, such as for example a base station, User Equipment (UE), station (STA), or any wireless communication device, that includes a device as disclosed herein (or a device manufactured as disclosed herein).

Specific example embodiments will now be described.

FIG. 2 shows a cross section of another example of a device 200 according to an embodiment of this disclosure. The device 200 includes a single package 202 with a plurality of primary antennas 204, and a secondary “antenna top” component 206 including a plurality of secondary antennas 208. The Component 206 is attached to the package 202 using a dispensed adhesive 210 or in other examples an adhesive film, after the package 202 is assembled onto a printed circuit board (PCB) 212. In this example, the component 206 covers all of the primary antennas 204 (though in other examples the component 206 may not cover all of the primary antennas 204). The package 202 also in this example includes signal routing 214 from the solder ball or solder joint to the integrated circuit in the package 202. The device 200 may include solder balls 216 that are used to provide mechanical and possibly electrical connection between the PCB 212 and the bottom package 202. The device 200 may also include optional underfill material 218 between the PCB 212 and the bottom package 202 and surrounds the solder balls 216, and is primarily used to enhance the reliability of the solder balls 216.

In some examples, a device according to this disclosure may use a fan-out wafer level package(s) as the bottom part(s) (both die first and die last options), with a further option in some examples to use molded dielectric layers to achieve enough thickness. Some examples may use redistribution (RDL) layers for limited bandwidth applications (very thin). An example is shown in FIG. 3, which shows a cross section of an example of a package 300. RDL layers 302 are disposed over the integrated circuit 304 and under the primary antennas 306, with vias 308 through the RDL layers. The package 300 may also include solder balls 310 that are used to provide mechanical and possibly electrical connection between to a PCB (not shown). Also shown is a through mold via (TMV) 312, one or more of which may be present in some examples to connect solder ball(s) 310 to the RDL layers 302.

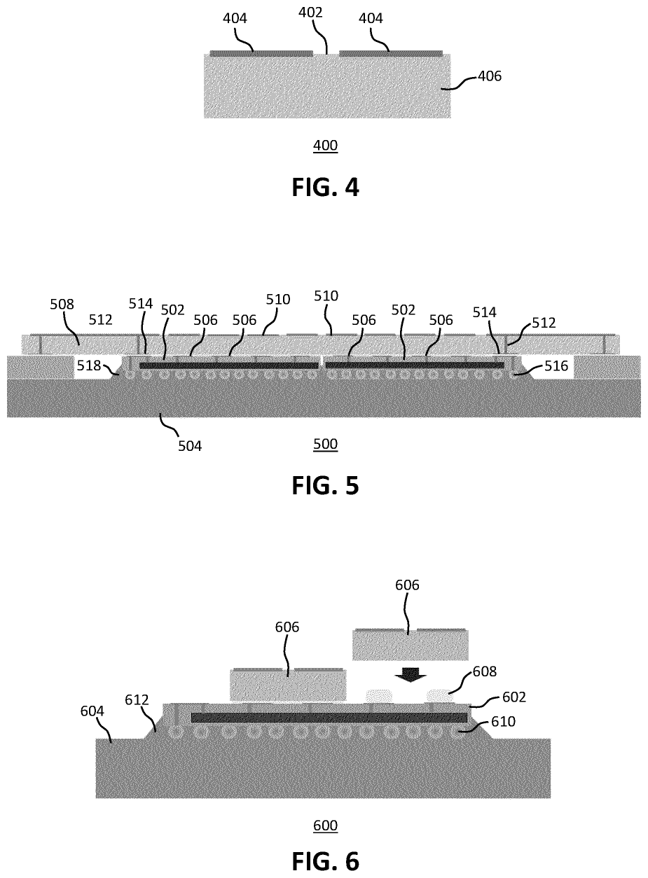

FIG. 4 shows a cross section of an example of a component 400, which may be included in a device or a method of manufacture of a device according to embodiments of this disclosure. As shown in FIG. 4, the component 400 is very simple to make, and in simplest form such as that shown in FIG. 4 does not have or require metal anywhere other than on the top surface 402, which includes the secondary antennas 404 (two of which are shown in FIG. 4, though in other examples there may be any number of one or more secondary antennas). This simplifies manufacturing of the component(s) and subsequent assembly onto the package(s). A simple thick single dielectric layer 406 may be used in some examples, with metal only on one side 402. It can be made for example from a microwave laminate core layer with copper patterned on one side and removed on the other side.

In some examples, component(s) or top part(s) include or are made of low permittivity material. This can be low Dk-laminate in some examples, with dielectric constant (Dk) around 1.5 (or in the range 1-1.5, 1-2, 1-2.5, etc.). This can be Teflon-based materials or foam type materials in some examples. The low Dk makes it possible to achieve good scan performance even without a via fence around the secondary antennas.

As suggested above, in some examples, the top part(s) (component(s)) may extend beyond at least one edge of the bottom part(s)/package(s) to reach surrounding objects, to cover gaps and/or to hide objects. This is shown as an example in FIG. 5, which shows a cross section of another example of a device 500 according to embodiments of this disclosure. The device 500 includes two packages 502 mounted on a PCB 504, each package 502 having primary antennas 506. The device 500 also includes one component 508 including secondary antennas 510.

Optionally, in the components(s), there can be one or more vias (e.g. vias 512 shown in FIG. 5), one or more bottom side pads (e.g. bottom side pads 514) and conductive adhesive (e.g. solder), in certain regions far from the antenna elements, that serve to connect to ground without influencing the near field of the antenna elements, and/or to connect integrated circuit(s) in the package(s) 502 for external signals. The device 500 may include solder balls 516 that are used to provide mechanical and possibly electrical connection between the PCB 504 and the bottom packages 502. The device 500 may also include optional underfill material 518 between the PCB 504 and the bottom packages 502 and surrounds the solder balls 516, and is primarily used to enhance the reliability of the solder balls 516.

In some examples, there may be multiple (two or more) top parts/components, instead of one larger component. This may better accommodate warpage for example. An example is shown in FIG. 6, which shows a cross section of another example of a device 600 according to embodiments of this disclosure. The device 600 includes one package 602 mounted on a PCB 604, and two components 606. One of the components 606 is shown before being attached to the package 602 using adhesive 608. In other examples there may be more than two components, and/or there may be more than one package. The device 600 may include solder balls 610 that are used to provide mechanical and possibly electrical connection between the PCB 604 and the bottom package 602. The device 600 may also include optional underfill material 612 between the PCB 604 and the bottom package 602 and surrounds the solder balls 610, and is primarily used to enhance the reliability of the solder balls 610.

In some examples, each primary antenna can be fed differentially, and thus there may be (at least) two vias connecting each primary antenna to the IC.

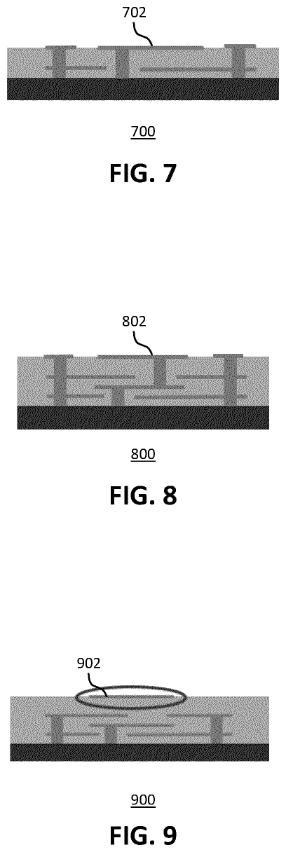

There are several options for implementing the primary antenna and feeding to it. For example, each primary antenna may be a patch, fed directly by a via (or multiple vias) from an integrated circuit. FIGS. 7-9 each show a cross section of a part of an example of a package. In particular, FIG. 7 shows a cross section of a part of an example of a package 700 that includes side ground adjacent to at least one of the primary antenna(s) 702 to limit coupling and to suppress surface wave retardation. It is possible in some examples to have an adaptation layer that allows re-routing to a new position, for example as shown in the example package 800 of FIG. 8, which also includes side ground adjacent to at least one of the primary antenna(s) 802. It is possible in some examples to add an additional aperture and patch to tailor the impedance match across a wider frequency band, for example as shown in the example package 900 of FIG. 9, where a primary antenna 902 is aperture fed, although this may in some examples result in larger total thickness, limited bandwidth, and high loss.

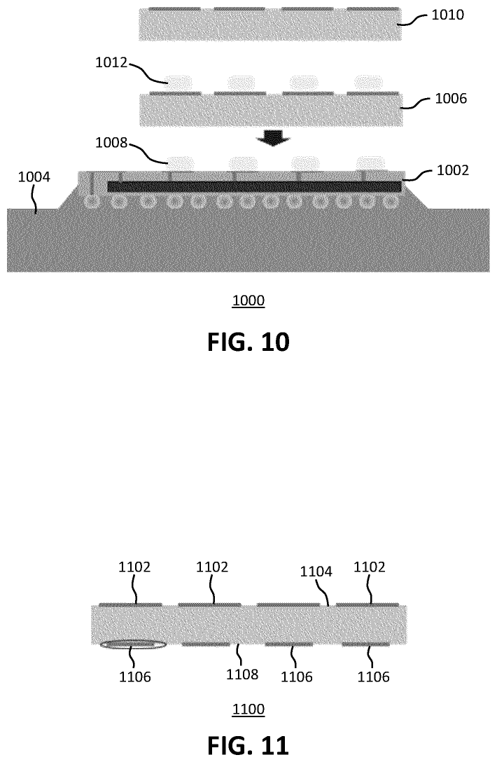

Some examples use additional component(s), referred to above in some examples as further component(s), to stack more than one top part. An example is shown in FIG. 10, which shows a cross section of another example of a device 1000 according to embodiments of this disclosure. The device 1000 includes a package 1002 mounted on a PCB 1004. A first component 1006 is to be attached to the package 1002 using adhesive 1008. A second component 1010 is to be attached to the first component 1006 using adhesive 1012.

As suggested above, the top part(s)/component(s) may in some examples be 100-500 um thick depending on frequency and bandwidth. In some examples, upper layers in the bottom part(s)/package(s) (e.g. layers between the primary antenna(s) and the IC(s)) may be 10-100 um thick depending on frequency and bandwidth.

In some examples, there may be an additional patch layer on the bottom side of the top part (referred to above in some examples as further antenna(s)). FIG. 11 shows a cross section of another example of a component 1100. The component includes secondary antennas 1102 on a first surface 1104 (e.g. the top surface in the orientation shown), and further antennas 1106 on a second surface 1108 (e.g. the bottom surface in the orientation shown) opposite the first surface 1104. The side of the component 1100 including the second surface 1108 and further antennas 1106 may for example be attached to one or more packages, or one or more components in an arrangement similar to that shown in FIG. 10.

Vias may be present inside component(s) in some examples, though these vias may have no direct electrical connection to the package(s) or integrated circuit(s). Some examples may include an adaptation layer that makes the position of IC-port independent of the position of the antenna port. In some examples, the package(s) may include active circuit(s) (e.g. IC(s)). Optionally the active circuit(s) cover a majority of the area behind the primary antenna elements.

In some examples, there is frequency conversion in the active circuit/package(s)/integrated circuit(s), such that package terminals will not have to handle high frequency signals. There may be multiple active circuits/ICs in the bottom part(s) in some examples, with interconnections within the bottom part(s). There can for example be a common frequency converting circuit that serves several phase shifting circuits. In some examples, two or more packages can be placed next to each other, such that an uninterrupted element grid is maintained.

In some examples, interface signals are fed in and out of the bottom part at on only 1-3 sides of the package, to minimize the element distance across a gap between two packages. That is, for example, adjacent packages may not include interface connection points at adjacent sides.

In some examples, active circuit(s) or IC(s) cover the whole antenna area, which makes re-routing unnecessary between antenna ports and active circuit ports. This may in some examples also allow the use of an active circuit ground as antenna ground. In simplest form, the ground for the antenna can be on the active circuit in the form of a ground mesh in some examples.

There may be an intermediate ground layer inside bottom part in some examples.

In some examples, there may be solder balls on the bottom side of the bottom part(s). Thermal solder balls may be present under the active circuits and a fully populated array of balls. Solder may be printed on a PCB (e.g. Land Grid Array, LGA, without solder balls on the package side).

In some examples, the bottom part can be fixed to the PCB with thermally conductive adhesive. Optionally the top part together with spacer components can serve as a bridge for interface signals to the PCB. Alternatively, in some examples, separate bridge components can be used, or wire-bonding or 3D-printing can be used.

The adhesive may be glue at least in part in some examples. Non-conductive epoxy (die-bond material), about 30 μm, optionally with fillers that give a fixed minimum distance, e.g. glass or ceramic fillers, may be used as an adhesive in some examples. In some examples, the device may be manufactured by holding the top part(s) (and optionally the bottom part(s) or PCB) hold until glue fixes the parts. Quick dry glue may be used, e.g. cyanoacrylate. In some examples the adhesive may be a mixture of glues, one instant/fast curing and one slow curing. In some examples, the adhesive may be a mixture of non-conductive and conductive glue, in different places. This may be used for example for ground connections for screening/grounding that are at sufficient distance from the antenna elements where high precision is not required. Some examples may use a preform B-stage that is sticky and will hold until set.

In some examples, at least part of the adhesive may be solder. The solder may for example be situated such that portions of the solder are between at least two primary antennas and/or between at least two secondary antennas, to avoid electrically connecting primary antennas, secondary antennas, or a primary antenna to a secondary antenna, for example.

In some examples, pattern/topography may be used as spacer in the adhesive on the top part(s) and/or bottom part(s). This may be for example the projections referred to above. This may be for example solder mask on bottom side of top part(s) or dielectric material on top of bottom part(s). In some examples, there may be a fine metallic pattern (e.g. diamond or circle shape pattern) on the bottom side of the top part to increase adhesion or reduce adhesive penetration for certain materials (foams, teflon, etc), or as part of achieving good copper balance and planarity.

In some examples, the adhesive is adhesive tape. This may not require elevated temperature, and may allow non-planarity, since pressure can be applied until the tape grabs in some examples.

Some examples may use laminate package optionally with pillars or balls on 1-4 sides to allow ICs under every antenna element.

In order to control the thickness of the adhesive, in some examples, a viscous adhesive with spacer fillers can be used, or an adhesive film with desired thickness can be used.

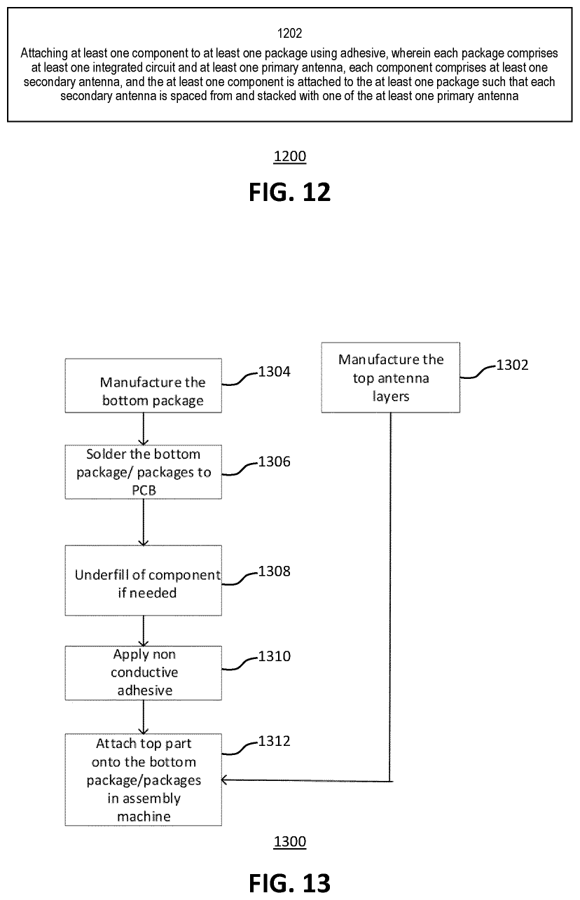

FIG. 12 is a flow chart of an example of a method 1200 of manufacture of a device. The method 1200 comprises, in step 1202, attaching at least one component to at least one package using adhesive, wherein each package comprises at least one integrated circuit and at least one primary antenna, each component comprises at least one secondary antenna, and the at least one component is attached to the at least one package such that each secondary antenna is spaced from and stacked with one of the at least one primary antenna.

FIG. 13 is a flow chart of another example of a method 1300 of manufacture of a device. The method 1300 of manufacture includes the following steps:

Step 1302: Manufacture top component(s).

Step 1304: Manufacture bottom package(s).

Step 1306: Solder bottom part(s) to PCB.

Step 1308: Apply underfill between bottom part(s) and PCB.

Step 1310: Apply adhesive on topside of bottom part(s) and/or on bottom side of top part(s).

Step 1312: Attach top part(s) onto bottom part(s).

It is possible to change the order of the manufacturing steps in some examples. For example, the non-conductive adhesive may be applied the top part(s) attached to bottom package(s) before mounting and soldering of the attached parts as a single component on a PCB.

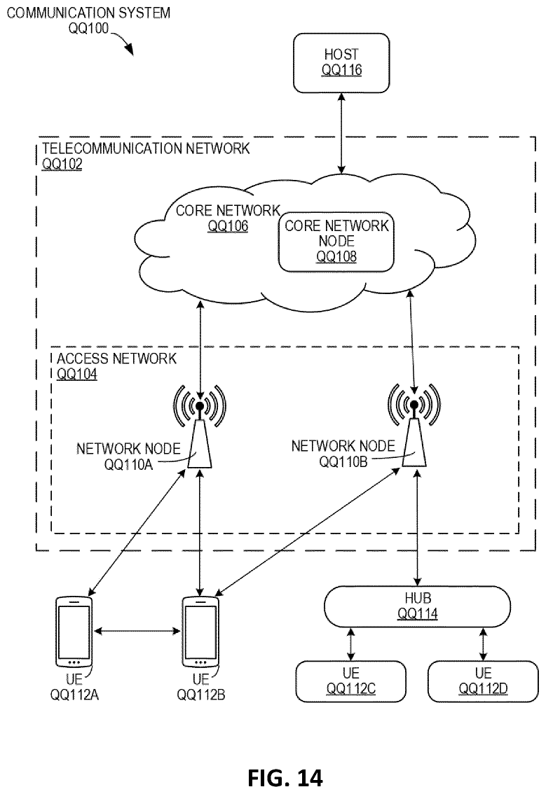

FIG. 14 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 14, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

In some examples, a network node and/or UE shown in FIG. 14 may include a device as disclosed herein and/or a device manufactured as disclosed herein.

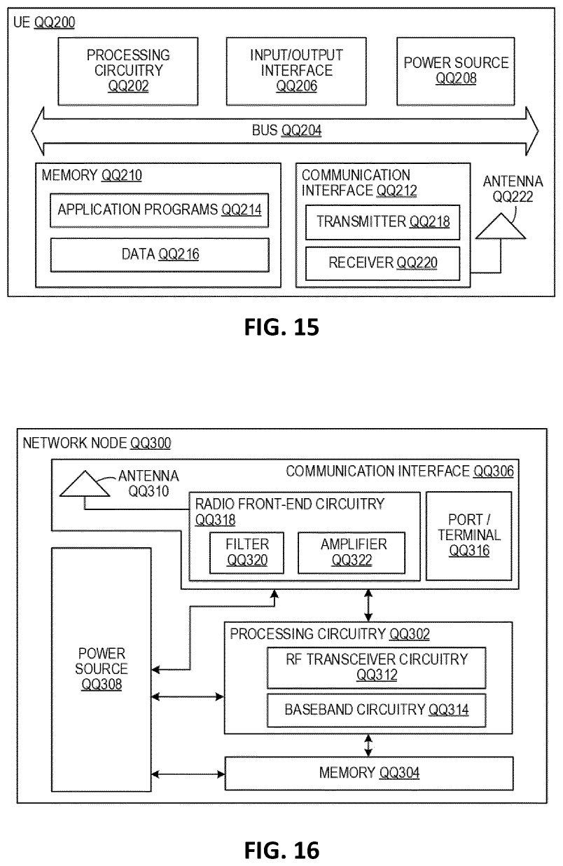

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately. In some examples, the communication interface QQ212 (e.g. the transmitter QQ218 and/or receiver QQ220) may include a device as disclosed herein and/or a device manufactured as disclosed herein.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components. In some examples, the radio front end circuitry QQ318 may include a device as disclosed herein and/or a device manufactured as disclosed herein

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

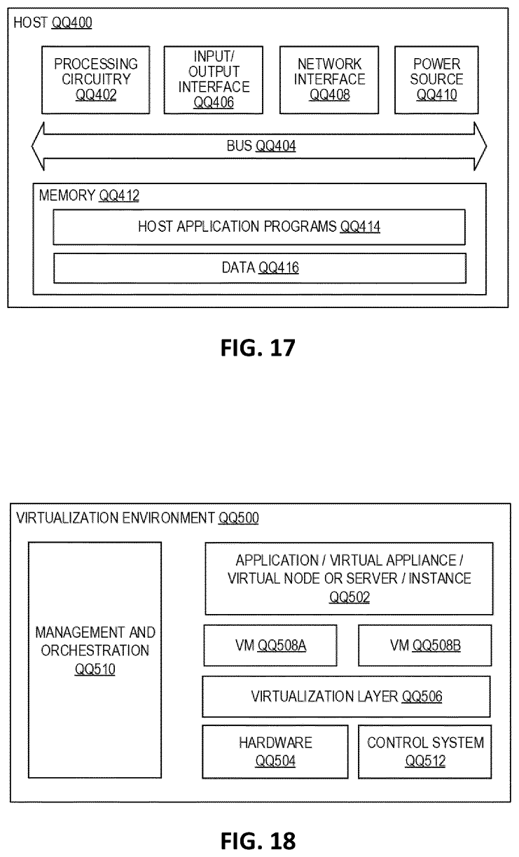

FIG. 17 is a block diagram of a host QQ400, which may be an embodiment of the host QQ116 of FIG. 14, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 15 and 16, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE.

Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

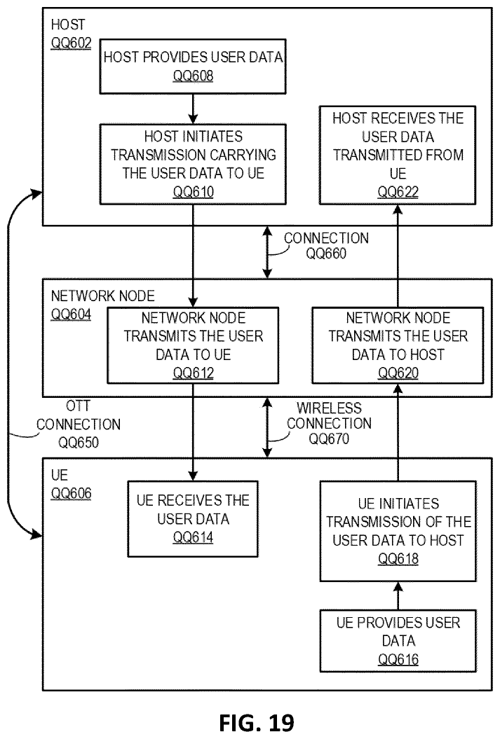

FIG. 19 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 17) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

1. A device comprising:
   at least one package, wherein each package comprises at least one integrated circuit and at least one primary antenna; and
   at least one component, wherein each component comprises at least one secondary antenna;
   wherein the at least one component is attached to the at least one package by adhesive such that each secondary antenna is spaced from and over one of the at least one primary antenna.
2. The device of embodiment 1, wherein the at least one package comprises one package, and wherein the package includes a plurality of primary antennas.
3. The device of embodiment 2, wherein the at least one component comprises a plurality of components, and wherein each of the components includes at least one secondary antenna.
4. The device of embodiment 2, wherein the at least one component comprises one component, and wherein the component includes a plurality of secondary antennas.
5. The device of embodiment 1, wherein the at least one component comprises one component.
6. The device of embodiment 5, wherein the at least one package comprises one package.
7. The device of embodiment 5, wherein the at least one package comprises a plurality of packages, each of the packages includes at least one primary antenna, and the component includes a plurality of secondary antennas.
8. The device of any of embodiments 1 to 7, wherein the at least one component is attached to the at least one package by adhesive such that one or more of the following applies:
   each secondary antenna is spaced from and over one of the at least one primary antenna such that each secondary antenna is substantially parallel to at least one primary antenna;
   each primary antenna is substantially equal in size and/or shape to at least one secondary antenna;
   each secondary antenna is spaced from and over one of the at least one primary antenna such that an area over the at least one package occupied by each secondary antenna is substantially equal to an area over the at least one package occupied by at least one primary antenna;
   each secondary antenna is spaced from and over one of the at least one primary antenna such that each primary antenna is underneath at least one secondary antenna;
   each secondary antenna is spaced from and over one of the at least one primary antenna such that each primary antenna is at least partially covered by at least one secondary antenna;
   there is no direct electrical connection between each primary antenna and any secondary antenna;
   there is no air gap between the at least one package and the at least one component;
   each secondary antenna is spaced from and over one of the at least one primary antenna such that each secondary antenna is located to be able to induce a signal in at least one primary antenna; and/or
   each secondary antenna is spaced from and over one of the at least one primary antenna such that each primary antenna is located to be able to induce a signal in at least one secondary antenna.
9. The device of any of embodiments 1 to 8, wherein each of the at least one component includes a substrate.
10. The device of embodiment 9, wherein the substrate is a low dielectric constant (Dk) substrate.
11. The device of embodiment 9 or 10, wherein the dielectric constant of the substrate is in a range 1-1.5, 1-2, or 1-2.5.
12. The device of any of embodiments 1 to 11, wherein each component comprises a surface, wherein the at least one primary antenna is on the surface.
13. The device of embodiment 12, wherein the surface is substantially parallel to and facing away from the at least one package.
14. The device of embodiment 13, wherein at least one component includes a further surface, wherein the further surface is opposite the surface.
15. The device of embodiment 14, wherein at least one component includes at least one further antenna on the further surface of the component, and wherein each further antenna is between one of the at least one primary antenna and one of the at least one secondary antenna and is separated from the primary antenna.
16. The device of embodiment 15, wherein each further antenna is separated from the primary antenna by at least the adhesive.
17. The device of any of embodiments 14 to 16, wherein at least one component includes at least one projecting feature on the further surface that contacts a surface of at least one package.
18. The device of any of embodiments 1 to 17, wherein at least one package includes at least one projecting feature that contacts a surface of at least one component.
19. The device of any of embodiments 1 to 18, wherein the at least one component covers at least part of the at least one package.
20. The device of embodiment 19, wherein the at least one component extends beyond at least one edge of the at least one package.
21. The device of embodiment 20, wherein the component includes apparatus for providing one or more signals to at least one package and/or conveying one or more signals from the at least one package.
22. The device of embodiment 21, wherein a part of the adhesive is electrically conductive for electrically connecting the at least one component to the apparatus.
23. The device of any of embodiments 19 to 22, wherein the at least one component does not cover all of the at least one package.
24. The device of any of embodiments 1 to 23, wherein the at least one package includes at least one via electrically connected to the at least one primary antenna.
25. The device of any of embodiments 1 to 24, wherein the at least one package includes at least one first ground conductive portion adjacent to at least one primary antenna, wherein the at least one ground conductive portion is for connection to ground.
26. The device of any of embodiments 1 to 25, wherein the at least one package includes at least one second ground conductive portion under at least one primary antenna.
27. The device of embodiment 26, wherein the at least one second ground conductive portion includes or forms at least one aperture for providing a signal to the at least one primary antenna.
28. The device of any of embodiments 1 to 27, wherein the at least one package includes at least one via electrically connecting at least one primary antenna to the at least one integrated circuit.
29. The device of any of embodiments 1 to 28, further comprising at least one further component comprising at least one further secondary antenna, wherein the at least one further component is attached to the at least one component by adhesive such that each further secondary antenna is spaced from and over one of the at least one secondary antenna.
30. The device of any of embodiments 1 to 29, wherein a thickness of the at least one component is in a range 100-500 μm.
31. The device of any of embodiments 1 to 30, wherein the adhesive is electrically non-conductive, and/or the adhesive comprises a dispensed liquid adhesive, adhesive tape and/or an adhesive film.
32. The device of any of embodiments 1 to 31, wherein the at least one integrated circuit is under some or all of the at least one primary antenna.
33. The device of any of embodiments 1 to 32, wherein the at least one package comprises at least one integrated circuit embedded in a printed circuit board laminate stack.
34. A device comprising:
   at least one package, wherein each package comprises at least one integrated circuit and a plurality of primary antennas; and
   at least one component, wherein the component comprises a plurality of secondary antennas;
   wherein the at least one component is attached to the at least one package by solder such that each secondary antenna is spaced from and over one of the at least one primary antenna, wherein portions of the solder are between at least two primary antennas and/or at least two secondary antennas.
35. The device of embodiment 34, wherein the at least one package comprises one package.
36. The device of embodiment 35, wherein the at least one component comprises a plurality of components.
37. The device of embodiment 35, wherein the at least one component comprises one component.
38. The device of embodiment 34, wherein the at least one component comprises one component.
39. The device of embodiment 38, wherein the at least one package comprises one package.
40. The device of embodiment 38, wherein the at least one package comprises a plurality of packages, and each of the packages includes at least one primary antenna.
41. The device of any of embodiments 34 to 40, wherein the at least one component is attached to the at least one package by adhesive such that one or more of the following applies:
   each secondary antenna is spaced from and over one of the at least one primary antenna such that each secondary antenna is substantially parallel to at least one primary antenna;
   each primary antenna is substantially equal in size and/or shape to at least one secondary antenna;
   each secondary antenna is spaced from and over one of the at least one primary antenna such that an area over the at least one package occupied by each secondary antenna is substantially equal to an area over the at least one package occupied by at least one primary antenna;
   each secondary antenna is spaced from and over one of the at least one primary antenna such that each primary antenna is underneath at least one secondary antenna;
   each secondary antenna is spaced from and over one of the at least one primary antenna such that each primary antenna is at least partially covered by at least one secondary antenna;
   there is no direct electrical connection between each primary antenna and any secondary antenna;
   there is no air gap between the at least one package and the at least one component;
   each secondary antenna is spaced from and over one of the at least one primary antenna such that each secondary antenna is located to be able to induce a signal in at least one primary antenna; and/or
   each secondary antenna is spaced from and over one of the at least one primary antenna such that each primary antenna is located to be able to induce a signal in at least one secondary antenna.
42. The device of any of embodiments 34 to 41, wherein each of the at least one component includes a substrate.
43. The device of embodiment 42, wherein the substrate is a low dielectric constant (Dk) substrate.
44. The device of embodiment 42 or 43, wherein the dielectric constant of the substrate is in a range 1-1.5, 1-2, or 1-2.5.
45. The device of any of embodiments 34 to 44, wherein each component comprises a surface, wherein the primary antennas are on the surface.
46. The device of embodiment 45, wherein the surface is substantially parallel to and facing away from the at least one package.
47. The device of embodiment 46, wherein at least one component includes a further surface, wherein the further surface is opposite the surface.
48. The device of embodiment 47, wherein at least one component includes a plurality of further antennas on the further surface of the component, and wherein each further antenna is between one of the at least one primary antenna and one of the at least one secondary antenna and is separated from the primary antenna.
49. The device of embodiment 47 or 48, wherein at least one component includes at least one projecting feature on the further surface that contacts a surface of at least one package.
50. The device of any of embodiments 34 to 49, wherein at least one package includes at least one projecting feature that contacts a surface of at least one component.
51. The device of any of embodiments 34 to 50, wherein the at least one component covers at least part of the at least one package.
52. The device of embodiment 51, wherein the at least one component extends beyond at least one edge of the at least one package.
53. The device of embodiment 52, wherein the component includes apparatus for providing one or more signals to at least one package and/or conveying one or more signals from the at least one package.
54. The device of any of embodiments 51 to 53, wherein the at least one component does not cover all of the at least one package.
55. The device of any of embodiments 34 to 54, wherein the at least one package includes at least one via electrically connected to at least one primary antenna.
56. The device of any of embodiments 34 to 55, wherein the at least one package includes at least one first ground conductive portion adjacent to at least one primary antenna, wherein the at least one ground conductive portion is for connection to ground.
57. The device of any of embodiments 34 to 56, wherein the at least one package includes at least one second ground conductive portion under at least one primary antenna.
58. The device of embodiment 57, wherein the at least one second ground conductive portion includes or forms at least one aperture for providing a signal to the at least one primary antenna.
59. The device of any of embodiments 34 to 58, wherein the at least one package includes at least one via electrically connecting at least one primary antenna to the at least one integrated circuit.
60. The device of any of embodiments 34 to 59, further comprising at least one further component comprising at least one further secondary antenna, wherein the at least one further component is attached to the at least one component such that each further secondary antenna is spaced from and over one of the at least one secondary antenna.
61. The device of any of embodiments 34 to 60, wherein a thickness of the at least one component is in a range 100-500 μm.
62. The device of any of embodiments 34 to 61, wherein the at least one integrated circuit is under some or all of the at least one primary antenna.
63. The device of any of embodiments 34 to 62, wherein the at least one package comprises at least one integrated circuit embedded in a printed circuit board laminate stack.
64. A method of manufacture of a device, the method comprising:
   attaching at least one component to at least one package using adhesive;
   wherein each package comprises at least one integrated circuit and at least one primary antenna,
   wherein each component comprises at least one secondary antenna,
   and wherein the at least one component is attached to the at least one package such that each secondary antenna is spaced from and over one of the at least one primary antenna.
65. The method of embodiment 64, comprising mounting the device or the at least one package on a printed circuit board (PCB) after attaching the at least one component to the at least one package.
66. The method of embodiment 64, comprising mounting the at least one package on a printed circuit board (PCB) before attaching the at least one component to the at least one package.
67. The method of embodiment 65 or 66, comprising underfilling at least the at least one package on the PCB.
68. The method of any of embodiments 64 to 67, wherein the at least one package comprises one package, and wherein the package includes a plurality of primary antennas.
69. The method of embodiment 68, wherein the at least one component comprises a plurality of components, and wherein each of the components includes at least one secondary antenna.
70. The method of embodiment 68, wherein the at least one component comprises one component, and wherein the component includes a plurality of secondary antennas.
71. The method of any of embodiments 64 to 67, wherein the at least one component comprises one component.
72. The method of embodiment 71, wherein the at least one package comprises one package.
73. The method of embodiment 71, wherein the at least one package comprises a plurality of packages, each of the packages includes at least one primary antenna, and the component includes a plurality of secondary antennas.
74. The method of any of embodiments 64 to 73, wherein the at least one component is attached to the at least one package by adhesive such that one or more of the following applies:
   each secondary antenna is spaced from and over one of the at least one primary antenna such that each secondary antenna is substantially parallel to at least one primary antenna;
   each primary antenna is substantially equal in size and/or shape to at least one secondary antenna;
   each secondary antenna is spaced from and over one of the at least one primary antenna such that an area over the at least one package occupied by each secondary antenna is substantially equal to an area over the at least one package occupied by at least one primary antenna;
   each secondary antenna is spaced from and over one of the at least one primary antenna such that each primary antenna is underneath at least one secondary antenna;
   each secondary antenna is spaced from and over one of the at least one primary antenna such that each primary antenna is at least partially covered by at least one secondary antenna;
   there is no direct electrical connection between each primary antenna and any secondary antenna;
   there is no air gap between the at least one package and the at least one component;
   each secondary antenna is spaced from and over one of the at least one primary antenna such that each secondary antenna is located to be able to induce a signal in at least one primary antenna; and/or
   each secondary antenna is spaced from and over one of the at least one primary antenna such that each primary antenna is located to be able to induce a signal in at least one secondary antenna.
75. The method of any of embodiments 64 to 74, wherein each of the at least one component includes a substrate.
76. The method of embodiment 75, wherein the substrate is a low dielectric constant (Dk) substrate.
77. The method of embodiment 75 or 76, wherein the dielectric constant of the substrate is in a range 1-1.5, 1-2, or 1-2.5.
78. The method of any of embodiments 64 to 77, wherein each component comprises a surface, wherein the at least one primary antenna is on the surface.
79. The method of embodiment 78, wherein attaching at least one component to at least one package comprises attaching at least one component to at least one package such that the surface is substantially parallel to and facing away from the at least one package.
80. The method of embodiment 79, wherein at least one component includes a further surface, wherein the further surface is opposite the surface.
81. The method of embodiment 80, wherein at least one component includes at least one further antenna on the further surface of the component, and wherein attaching at least one component to at least one package comprises attaching at least one component to at least one package such that each further antenna is between one of the at least one primary antenna and one of the at least one secondary antenna and is separated from the primary antenna.
82. The method of embodiment 81, wherein attaching at least one component to at least one package comprises attaching at least one component to at least one package such that each further antenna is separated from the primary antenna by at least the adhesive.
83. The method of any of embodiments 80 to 82, wherein at least one component includes at least one projecting feature on the further surface, and wherein attaching at least one component to at least one package comprises attaching at least one component to at least one package such that the at least one projecting feature contacts a surface of at least one package.
84. The method of any of embodiments 64 to 83, wherein at least one package includes at least one projecting feature, and wherein attaching at least one component to at least one package comprises attaching at least one component to at least one package such that the at least one projecting feature contacts a surface of at least one component.
85. The method of any of embodiments 64 to 84, wherein attaching at least one component to at least one package comprises attaching at least one component to at least one package such that the at least one component covers at least part of the at least one package.
86. The method of embodiment 85, wherein attaching at least one component to at least one package comprises attaching at least one component to at least one package such that the at least one component extends beyond at least one edge of the at least one package.
87. The method of embodiment 86, wherein the component includes apparatus for providing one or more signals to at least one package and/or conveying one or more signals from the at least one package.
88. The method of embodiment 87, wherein a part of the adhesive is electrically conductive for electrically connecting the at least one component to the apparatus.
89. The method of any of embodiments 85 to 88, wherein attaching at least one component to at least one package comprises attaching at least one component to at least one package such that the at least one component does not cover all of the at least one package.
90. The method of any of embodiments 64 to 89, wherein the at least one package includes at least one via electrically connected to at least one primary antenna.
91. The method of any of embodiments 64 to 90, wherein the at least one package includes at least one first ground conductive portion adjacent to at least one primary antenna, wherein the at least one ground conductive portion is for connection to ground.
92. The method of any of embodiments 64 to 91, wherein the at least one package includes at least one second ground conductive portion under at least one primary antenna.
93. The method of embodiment 92, wherein the at least one second ground conductive portion includes or forms at least one aperture for providing a signal to the at least one primary antenna.
94. The method of any of embodiments 64 to 93, wherein the at least one package includes at least one via electrically connecting at least one primary antenna to the at least one integrated circuit.
95. The method of any of embodiments 64 to 94, further comprising at least one further component comprising at least one further secondary antenna, and wherein the method further comprises attaching the at least one further component to the at least one component using adhesive such that each further secondary antenna is spaced from and over one of the at least one secondary antenna.
96. The method of any of embodiments 64 to 95, wherein a thickness of the at least one component is in a range 100-500 μm.
97. The method of any of embodiments 64 to 96, wherein the adhesive is electrically non-conductive, and/or the adhesive comprises a dispensed liquid adhesive, adhesive tape and/or an adhesive film.
98. The method of any of embodiments 64 to 97, wherein attaching at least one component to at least one package comprises attaching at least one component to at least one package such that the at least one integrated circuit is under some or all of the at least one primary antenna.
99. The method of any of embodiments 64 to 98, wherein the at least one package comprises at least one integrated circuit embedded in a printed circuit board laminate stack.
100. The method of any of embodiments 64 to 99, further comprising: manufacturing the at least one component; and/or manufacturing the at least one package.
101. A method of manufacture of a device, the method comprising:
   attaching at least one component to at least one package using solder;
   wherein each package comprises at least one integrated circuit and a plurality of primary antennas,
   wherein each component comprises a plurality of secondary antennas,
   and wherein the at least one component is attached to the at least one package such that that each secondary antenna is spaced from and over one of the at least one primary antenna, and portions of the solder are between at least two primary antennas and/or at least two secondary antennas.
102. The method of embodiment 102, comprising mounting the device or the at least one package on a printed circuit board (PCB) after attaching the at least one component the to at least one package.
103. The method of embodiment 102, comprising mounting the at least one package on a printed circuit board (PCB) before attaching the at least one component the to at least one package.
104. The method of embodiment 102 or 103, comprising underfilling at least the at least one package on the PCB.
105. The method of any of embodiments 101 to 104, wherein the at least one package comprises one package.
106. The method of embodiment 105, wherein the at least one component comprises a plurality of components, and wherein each of the components includes at least one secondary antenna.
107. The method of embodiment 105, wherein the at least one component comprises one component.
108. The method of any of embodiments 101 to 107, wherein the at least one component comprises one component.
109. The method of embodiment 108, wherein the at least one package comprises one package.
110. The method of embodiment 108, wherein the at least one package comprises a plurality of packages, and each of the packages includes at least one primary antenna.
111. The method of any of embodiments 101 to 110, wherein the at least one component is attached to the at least one package by adhesive such that one or more of the following applies:
   each secondary antenna is spaced from and over one of the at least one primary antenna such that each secondary antenna is substantially parallel to at least one primary antenna;
   each primary antenna is substantially equal in size and/or shape to at least one secondary antenna;
   each secondary antenna is spaced from and over one of the at least one primary antenna such that an area over the at least one package occupied by each secondary antenna is substantially equal to an area over the at least one package occupied by at least one primary antenna;
   each secondary antenna is spaced from and over one of the at least one primary antenna such that each primary antenna is underneath at least one secondary antenna;
   each secondary antenna is spaced from and over one of the at least one primary antenna such that each primary antenna is at least partially covered by at least one secondary antenna;
   there is no direct electrical connection between each primary antenna and any secondary antenna;
   there is no air gap between the at least one package and the at least one component;
   each secondary antenna is spaced from and over one of the at least one primary antenna such that each secondary antenna is located to be able to induce a signal in at least one primary antenna; and/or
   each secondary antenna is spaced from and over one of the at least one primary antenna such that each primary antenna is located to be able to induce a signal in at least one secondary antenna.
112. The method of any of embodiments 101 to 111, wherein each of the at least one component includes a substrate.
113. The method of embodiment 112, wherein the substrate is a low dielectric constant (Dk) substrate.
114. The method of embodiment 112 or 113, wherein the dielectric constant of the substrate is in a range 1-1.5, 1-2, or 1-2.5.
115. The method of any of embodiments 101 to 114, wherein each component comprises a surface, wherein the primary antennas are on the surface.
116. The method of embodiment 115, wherein attaching at least one component to at least one package comprises attaching at least one component to at least one package such that the surface is substantially parallel to and facing away from the at least one package.
117. The method of embodiment 116, wherein at least one component includes a further surface, wherein the further surface is opposite the surface.
118. The method of embodiment 117, wherein at least one component includes at least one further antenna on the further surface of the component, and wherein attaching at least one component to at least one package comprises attaching at least one component to at least one package such that each further antenna is between one of the at least one primary antenna and one of the at least one secondary antenna and is separated from the primary antenna.
119. The method of embodiment 117 or 118, wherein at least one component includes at least one projecting feature on the further surface, and wherein attaching at least one component to at least one package comprises attaching at least one component to at least one package such that the at least one projecting feature contacts a surface of at least one package.
120. The method of any of embodiments 101 to 119, wherein at least one package includes at least one projecting feature, and wherein attaching at least one component to at least one package comprises attaching at least one component to at least one package such that the at least one projecting feature contacts a surface of at least one component.
121. The method of any of embodiments 101 to 120, wherein attaching at least one component to at least one package comprises attaching at least one component to at least one package such that the at least one component covers at least part of the at least one package.
122. The method of embodiment 121, wherein attaching at least one component to at least one package comprises attaching at least one component to at least one package such that the at least one component extends beyond at least one edge of the at least one package.
123. The method of embodiment 122, wherein the component includes apparatus for providing one or more signals to at least one package and/or conveying one or more signals from the at least one package.
124. The method of any of embodiments 121 to 123, wherein attaching at least one component to at least one package comprises attaching at least one component to at least one package such that the at least one component does not cover all of the at least one package.
125. The method of any of embodiments 101 to 124, wherein the at least one package includes at least one via electrically connected to at least one primary antenna.
126. The method of any of embodiments 101 to 125, wherein the at least one package includes at least one first ground conductive portion adjacent to at least one primary antenna, wherein the at least one ground conductive portion is for connection to ground.
127. The method of any of embodiments 101 to 126, wherein the at least one package includes at least one second ground conductive portion under at least one primary antenna.
128. The method of embodiment 127, wherein the at least one second ground conductive portion includes or forms at least one aperture for providing a signal to the at least one primary antenna.
129. The method of any of embodiments 101 to 128, wherein the at least one package includes at least one via electrically connecting at least one primary antenna to the at least one integrated circuit.
130. The method of any of embodiments 101 to 129, further comprising at least one further component comprising at least one further secondary antenna, and wherein the method further comprises attaching the at least one further component to the at least one component such that each further secondary antenna is spaced from and over one of the at least one secondary antenna.
131. The method of any of embodiments 101 to 130, wherein a thickness of the at least one component is in a range 100-500 μm.
132. The method of any of embodiments 101 to 131, wherein attaching at least one component to at least one package comprises attaching at least one component to at least one package such that the at least one integrated circuit is under some or all of the at least one primary antenna.
133. The method of any of embodiments 101 to 132, wherein the at least one package comprises at least one integrated circuit embedded in a printed circuit board laminate stack.
134. The method of any of embodiments 101 to 133, further comprising:
   manufacturing the at least one component; and/or
   manufacturing the at least one package.

1-54. (canceled)

55. A device comprising:
at least one package, wherein each package comprises at least one integrated circuit and at least one primary antenna; and
at least one component, wherein each component comprises at least one secondary antenna;
wherein the at least one component is attached to the at least one package by adhesive such that each secondary antenna is spaced from and stacked with one of the at least one primary antenna.

56. The device of claim 55, wherein the at least one package comprises one package, and the package includes a plurality of primary antennas, and wherein:
the at least one component comprises a plurality of components and each of the components includes at least one secondary antenna; or
the at least one component comprises one component, and wherein the component includes a plurality of secondary antennas.

57. The device of claim 55, wherein the at least one component comprises one component, and wherein:
the at least one package comprises one package, or
the at least one package comprises a plurality of packages, each of the packages includes at least one primary antenna, and the component includes a plurality of secondary antennas.

58. The device of claim 55, comprising:
a plurality of primary antennas including the at least one primary antenna; and
a plurality of secondary antennas including the at least one secondary antenna;
wherein the adhesive comprises solder, and the at least one component is attached to the at least one package such that each secondary antenna is spaced from and stacked with one of the at least one primary antenna, wherein portions of the solder are between at least two primary antennas and/or between at least two secondary antennas.

59. The device of claim 55, wherein the at least one component is attached to the at least one package by adhesive such that one or more of the following applies:
each secondary antenna is spaced from and stacked with one of the at least one primary antenna such that each secondary antenna is substantially parallel to at least one primary antenna;
each primary antenna occupies an area that is substantially equal in size and/or shape to at least one secondary antenna;
each secondary antenna is spaced from and stacked with one of the at least one primary antenna such that an area over the at least one package occupied by each secondary antenna is substantially equal to an area over the at least one package occupied by at least one primary antenna;
each secondary antenna is spaced from and stacked with one of the at least one primary antenna such that each primary antenna is underneath at least one secondary antenna;
each secondary antenna is spaced from and stacked with one of the at least one primary antenna such that each primary antenna is at least partially covered by at least one secondary antenna;
there is no direct electrical connection between each primary antenna and any secondary antenna;
there is no direct electrical connection between ground structures in the primary antenna and each secondary antenna;
there is no air gap between the at least one package and the at least one component;
each secondary antenna is spaced from and stacked with one of the at least one primary antenna such that each secondary antenna is located to be able to induce a signal in at least one primary antenna; and/or
each secondary antenna is spaced from and stacked with one of the at least one primary antenna such that each primary antenna is located to be able to induce a signal in at least one secondary antenna.

60. The device of claim 55, wherein each of the at least one component includes a substrate having a dielectric constant in a range of 1-2.5.

61. The device of claim 55, wherein each component comprises a surface, wherein the at least one primary antenna is on the surface, wherein the surface is substantially parallel to and facing away from the at least one package, and wherein at least one component includes a further surface, wherein the further surface is opposite the surface, and at least one component includes at least one further antenna on the further surface of the component, and wherein each further antenna is between one of the at least one primary antenna and one of the at least one secondary antenna and is separated from the primary antenna.

62. The device of claim 55, wherein the at least one package includes at least one first ground conductive portion adjacent to at least one primary antenna, wherein the at least one ground conductive portion is for connection to ground, and/or at least one second ground conductive portion under at least one primary antenna.

63. The device of claim 62, wherein the at least one second ground conductive portion includes or forms at least one aperture for providing a signal to the at least one primary antenna.

64. The device of claim 55, further comprising at least one further component comprising at least one further secondary antenna, wherein the at least one further component is attached to the at least one component by adhesive such that each further secondary antenna is spaced from and stacked with one of the at least one secondary antenna.

65. The device of claim 55, wherein the at least one integrated circuit is under some or all of the at least one primary antenna.

66. The device of claim 55, wherein the at least one package comprises at least one integrated circuit embedded in a printed circuit board laminate stack, and/or at least one integrated circuit embedded in a package with one or more molded dielectric layers or RDL layers.

67. The device of claim 55, comprising:
a plurality of primary antennas including the at least one primary antenna; and
a plurality of secondary antennas including the at least one secondary antenna;
wherein the adhesive comprises solder, and the at least one component is attached to the at least one package such that each secondary antenna is spaced from and stacked with one of the at least one primary antenna, wherein portions of the solder are between at least two primary antennas and/or between at least two secondary antennas.

68. A method of manufacture of a device, the method comprising:
attaching at least one component to at least one package using adhesive;
wherein each package comprises at least one integrated circuit and at least one primary antenna,
wherein each component comprises at least one secondary antenna,
and wherein the at least one component is attached to the at least one package such that each secondary antenna is spaced from and stacked with one of the at least one primary antenna.

69. The method of claim 68, comprising mounting the device or the at least one package on a printed circuit board (PCB) after attaching the at least one component to the at least one package or before attaching the at least one component to the at least one package.

70. The method of claim 69, comprising underfilling at least the at least one package on the PCB.

71. The method of claim 68, wherein the at least one package comprises one package, and wherein the package includes a plurality of primary antennas, and wherein:
the at least one component comprises a plurality of components, and each of the components includes at least one secondary antenna; or
the at least one component comprises one component, and wherein the component includes a plurality of secondary antennas.

72. The method of claim 68, wherein the at least one component comprises one component, and wherein:
the at least one package comprises one package; or
the at least one package comprises a plurality of packages, each of the packages includes at least one primary antenna, and the component includes a plurality of secondary antennas.

73. The method of claim 68, wherein:
the adhesive comprises solder;
each package comprises a plurality of primary antennas including the at least one primary antenna;
each component comprises a plurality of secondary antennas including the secondary antenna; and
the at least one component is attached to the at least one package such that each secondary antenna is spaced from and stacked with one of the at least one primary antenna, and portions of the solder are between at least two primary antennas and/or at least two secondary antennas.

74. The method of claim 68, wherein the at least one component is attached to the at least one package by adhesive such that one or more of the following applies:
each secondary antenna is spaced from and stacked with one of the at least one primary antenna such that each secondary antenna is substantially parallel to at least one primary antenna;
each primary antenna is substantially equal in size and/or shape to at least one secondary antenna;
each secondary antenna is spaced from and stacked with one of the at least one primary antenna such that an area over the at least one package occupied by each secondary antenna is substantially equal to an area over the at least one package occupied by at least one primary antenna;
each secondary antenna is spaced from and stacked with one of the at least one primary antenna such that each primary antenna is underneath at least one secondary antenna;
each secondary antenna is spaced from and stacked with one of the at least one primary antenna such that each primary antenna is at least partially covered by at least one secondary antenna;
there is no direct electrical connection between each primary antenna and any secondary antenna;
there is no air gap between the at least one package and the at least one component;
each secondary antenna is spaced from and stacked with one of the at least one primary antenna such that each secondary antenna is located to be able to induce a signal in at least one primary antenna; and/or
each secondary antenna is spaced from and stacked with one of the at least one primary antenna such that each primary antenna is located to be able to induce a signal in at least one secondary antenna.

75. The method of claim 80, wherein each component comprises a surface, wherein the at least one primary antenna is on the surface, wherein attaching at least one component to at least one package comprises attaching at least one component to at least one package such that the surface is substantially parallel to and facing away from the at least one package, wherein at least one component includes a further surface, wherein the further surface is opposite the surface, wherein at least one component includes at least one further antenna on the further surface of the component, and wherein attaching at least one component to at least one package comprises attaching at least one component to at least one package such that each further antenna is between one of the at least one primary antenna and one of the at least one secondary antenna and is separated from the primary antenna.

76. The method of claim 76, wherein attaching at least one component to at least one package comprises attaching at least one component to at least one package such that each further antenna is separated from the primary antenna by at least the adhesive.

77. The method of claim 68, wherein attaching at least one component to at least one package comprises attaching at least one component to at least one package such that the at least one component covers at least part of the at least one package.

78. The method of claim 77, wherein attaching at least one component to at least one package comprises attaching at least one component to at least one package such that the at least one component extends beyond at least one edge of the at least one package.

79. The method of claim 78, wherein the component includes apparatus for providing one or more signals to at least one package and/or conveying one or more signals from the at least one package.
